(19) United States
(12) Patent Application Publication
(10) Pub. No.: US 2011/0081476 A1
(43) Pub. Date: Apr. 7, 2011

(54) SYRUP COMPOSITION

(75) Inventors: Chae-Jin Lee, Seoul (KR); Hee-Soon Cheon, Seoul (KR); Jun-Bong Choi, Seoul (KR)

(73) Assignee: CJ Cheiljedang Corp., Seoul (KR)

(21) Appl. No.: 12/996,233

(22) PCT Filed: Jun. 9, 2009
(86) PCT No.: PCT/KR2009/003094

§ 371 Date: Dec. 3, 2010

(30) Foreign Application Priority Data
Jun. 10, 2008 (KR) 10-2008-0054246

(51) Int. Cl. A23L 1/09

(52) U.S. Cl. 426/650

(57) ABSTRACT

The present invention provides a syrup composition prepared by adding fructo-oligosaccharide, erythritol, glucose, konjac powder, and an edible salt in place of sugar, fat, and starch syrup. The syrup composition can be valuably used in the food processing industry, as products of glutinous rice snacks, such as granola bars, made from the syrup composition show improved quality and have soft and crispy textures as well as fewer calories and softer flavors.

### TECHNICAL FIELD

The present invention relates to a syrup composition, and more particularly, to a syrup composition characterized by using fructo-oligosaccharide, erythritol, powdered glucose, konjac, and lecithine in place of fat and sugar. Further particularly, exemplary embodiments of the inventive concept relate to a syrup composition for preparing glutinous rice crackers such as granola bars having soft textures as well as fewer calories and sweeter tastes by adding konjac in the syrup preparation.

### BACKGROUND ART

Glutinous rice snack products such as glutinous rice crackers, sugar-coated snacks, and granola bars are prepared by mixing various dry ingredients with saccharide syrup, and specifically, granola is a meal substitute or snack, commercially prepared in a bar type by mixing rolled oats made by peeling, steaming and crushing oats with a roller, dry fruits and so forth with honey, syrup, or sugar, and crisply baking it in an oven.

Generally, to prepare the glutinous rice snacks such as granola in a bar type, syrup is used as an ingredient combining other ingredients such as rolled oats. The syrup may be prepared in liquid sugar or liquid fructose by melting sugar and fat and adding various flavors and fruit juices, and thus are high in calories, resulting in obesity and lifestyle diseases.

Further, to provide soft textures and sweet tastes to the granola bars, in some products, textures are maintained by adding starch syrup, sugar and fat, which, however, may be high in calories and cause tooth decay.

To solve such a problem, dietary fiber is added to the syrup in place of sugar to reduce calories in some products. However, when such syrup is applied to the granola bars, the product becomes harder and sticks to the teeth, which makes it difficult to use the syrup. Generally, when fat is used to provide soft textures, calories may be increased.

As conventional techniques related to granola, “fondant and method of preparing a food bar using the same” in Korean Patent Application No. 10-1986-2779, and “low- or non-fat granola grain mix and method of preparing the same” in Korean Patent Application No. 10-1993-16994 are disclosed. However, these techniques are merely provided to adjust components for granola bars, or improve the methods of preparing the same. There is a lack of development of technology related to syrup used for granola bars.

Korean Patent Application No. 10-2007-0047606 teaches a method of preparing non-sugar syrup by dissolving water-soluble dietary fiber, water, gum, a natural stabilizer and a sweetener. However, the said syrup includes a large content of dietary fiber for using in the manufacturing bread and ice cream. Hence, it is difficult to provide softness and textures to the granola bars. Further, since artificial and natural sweeteners are used, it does not seem that their tastes are similar to a natural sweet taste.

To improve the conventional problems described above, the inventors have conducted assiduous research, and prepared syrup having lower calories and soft textures, and applied the syrup to prepare glutinous rice snacks, sugar-coated snacks, and granola bars, thereby preparing a product with soft texture and a high-quality sweet taste. Therefore, the inventors completed the inventive concept, which had not been disclosed in the conventional art.

### DISCLOSURE

### Technical Problem

The present invention provides a syrup composition for preparing glutinous rice snacks such as granola bars with soft textures without adding sugar and fat and a method of preparing the same.

### Technical Solution

The present invention is directed to a syrup composition for preparing glutinous rice snacks such as granola bars, which is prepared by adding fructo-oligosaccharide, erythritol, glucose, and konjak powder in place of sugar and fat. Further, a granola bar with soft texture and a high-quality sweet taste is prepared using the same.

In accordance with an aspect of the inventive concept, a syrup composition is provided, which contains sugars or saccharide substitutes characterized in that it contains konjac powder.

In the syrup composition according to the inventive concept, the konjac powder may be contained at 1 to 5% by weight with respect to the total weight of the syrup composition.

In accordance with another aspect of the inventive concept, a syrup composition is provided, which is characterized in that is contains fructo-oligosaccharide, erythritol, glucose, konjac powder, edible salt and water.

The syrup composition according to the inventive concept is composed of 10 to 20 parts by weight, preferably 14 parts by weight, of erythritol; 10 to 20 parts by weight, preferably 13 parts by weight, of glucose; 1 to 5 parts by weight, preferably 2 parts by weight, of konjac powder; 1 to 4 parts by weight, preferably 2.3 parts by weight, of edible salt; and 15 to 25 parts by weight, preferably 20 parts by weight, of water; with respect to 100 parts by weight of the fructo-oligosaccharide. The syrup composition according to the inventive concept is prepared by a step of preparing a saccharide solution by adding 15 to 25 parts by weight of water with respect to 100 parts by weight of the fructo-oligosaccharide, and stirring the resultant mixture for 8 to 15 minutes, preferably 10 minutes, at 70 to 90° C., preferably 80° C.; a step of preparing syrup by adding 10 to 20 parts by weight, preferably 14 parts by weight, of erythritol, and 10 to 20 parts by weight, preferably 13 parts by weight, of glucose to the stirred solution and dissolving and concentrating the ingredients for 40 to 60 minutes, preferably 50 minutes, at 100 to 120° C.; and a step of adding 1 to 5 parts by weight, preferably 2 parts by weight, of konjac powder and 1 to 4 parts by weight, preferably 2.3 parts by weight, of edible salt to retain an optimum physical property.

Hereinafter, individual processes will be described.

1) Dissolution of Liquid Ingredients

In this process, fructo-oligosaccharide, as a sweetener, is mixed with water to prepare a saccharide solution, and then the solution is heated with stirring. It is appropriate for the saccharide solution to include 20 parts by weight of water with respect to 100 parts by weight of the sweetener. The solution is continuously heated with stirring until a temperature of the input solution is increased to 80° C.

2) Dissolution and Concentration of Granular Ingredients

When the temperature of the saccharide solution reaches 80° C., granular ingredients are added to the saccharide solution and dissolved. Here, the mixed granules are concentrated to contain, with respect to 100 parts by weight of a sweetener, 14 parts by weight of erythritol, 13 parts by weight of glucose, and 2.3 parts by weight of edible salt. During the steam heating for the concentration, an internal temperature is set to 110 to 120° C., and the final Brix is set as 85 to 87. Here, if the sugar content is 90 Brix or more, the syrup has a high intensity and thereby a final product hardens, and if the sugar content is 80 Brix, the syrup has a low settling strength and thus shape retention of a final product is not sufficient. During the dissolution, a stirrer is operated at a speed of 70 rpm.

3) Addition of Konjac Powder

After the syrup solution having reached the desired Brix is cooled in the air, the konjac powder is added in a content of 1.9 parts by weight with respect to 100 parts by weight of a sweetener, and then dispersed to dissolve. A main component of the added konjac powder is glucomanan, which is non-digestible polysaccharide. The glucomanan is low in calories, and also has gel formability, flowability, and thickening property, which helps a preparation process and an improvement in softness of the final product. The glucomanan also serves as a factor capable of continuously maintaining soft textures of the final products by preventing flow and release of moisture of the syrup, and thus keeping the products from being dried when the products are stored for a long time.

After the konjac powder is added and dissolved, the final viscosity of the syrup has to be retained at 100 cPoise on the basis of 90° C. And thus, in a subsequent process, breakdown of other nutrients to be mixed can be minimized in consideration of pipe transfer and mixture suitability with cereals.

Here, the total stirring time is proberbly about 1 hour, and if the stirring time is excessively long, browning of the syrup may occur.

The inventive concept provides the glutinous rice snacks, saccharide-coated snacks, and granola bars, which are prepared using the syrup composition.

The granola bars according to the inventive concept are prepared by mixing multigrain mix, isolated soy protein nuggets, soybean flakes, brown rice, wheat protein, barley, tropicalpis, minetamine, yogurt powder, psyllium husk, garcinia cambogia peel extract, and L-carnitine, adding the syrup composition thereto, and molding the resulting mixture.

4) Molding in Bar Type

After the multigrain mix, isolated soy protein nuggets, soybean flakes, brown rice, tropicalpis, and barley are weighed and then roasted in a roaster at 90° C. for 10 minutes, the prepared syrup is mixed with other grains in a ratio of 34 to 64.

The mixed blend is thinned to a thickness by steps using a roller, and then cooled in a cooling tunnel at 4° C. for about 12 minutes. The cooled blend is cut to length and width, weighed, and then packed into one package.

### Advantageous Effects

As described above, a syrup composition according to the inventive concept prepared by adding fructo-oligosaccharide, erythritol, glucose, konjac powder, and edible salt in place of sugar, fat, and starch syrup. Thus, the syrup composition is low in calories, and provides soft textures and crispy chewing property and increased product quality, which increases product power. As a result, the syrup composition can be valuably used in the food processing industry.

### Modes of the Invention

Hereinafter, exemplary embodiments of the present invention will be described in detail. However, the present invention is not limited to the exemplary embodiments disclosed below, but can be implemented in various modified forms. The present exemplary embodiments are provided to fully enable those of ordinary skill in the art to embody and practice the invention.

### EXAMPLE 1

### Preparation of Syrup Composition

A syrup composition according to the inventive concept was prepared with the ingredients and contents shown in Table 1.

TABLE 1
Ingredients and Contents of Syrup Composition

| Ingredients | Contents (g) |
|---|---|
| Fructo-oligosaccharide | 100 |
| Erythritol | 14 |
| Glucose | 13 |
| Edible Salt | 2.3 |
| Konjac Powder | 1.9 |
| Water | 20 |

To prepare the syrup composition according to the ingredients and contents of Table 1, first, water was added to fructo-oligosaccharide and stirred at 80° C. for 10 minutes. Erythritol, glucose, and edible salt were added and then heated at 120° C. to be concentrated to a Brix of 85 to 87.

The concentrated syrup was cooled in the air, and then the konjac powder was added to adjust a syrup property.

### EXAMPLE 2

### Preparation of Granola Bar

A granola bar was prepared using the syrup composition prepared in Example 1 with the ingredients and contents shown in Table 2.

TABLE 2
Ingredients and Contents of Granola Bar

| Ingredients | Contents (g) |
|---|---|
| Syrup | 34.034 |
| Multigrain mix | 18.767 |
| Isolated soy protein nuggets | 13.775 |
| Soybean flakes | 13.775 |
| Brown rice | 9.024 |
| Wheat protein | 3.500 |
| Barley | 2.137 |
| Tropicalpis | 1.867 |
| Minetamine | 1.677 |
| Yogurt Powder | 1.304 |
| Psyllium husk | 0.098 |
| Garcinia cambogia peel extract | 0.021 |
| L-carnitine | 0.021 |

After the materials were roasted in a roaster at 90° C. for 10 minutes, the prepared syrup was mixed with other grains in a ratio of 34 to 64, and the mixed blend was thinned to a thickness by steps using a roller, and cooled in a cooling tunnel at 4° C. for about 12 minutes. The cooled blend was cut to length and width, weighed, and packed into one package.

The granola bar obtained thereby had more soft and crispy textures.

### EXPERIMENTAL EXAMPLE 1

### Evaluation of Quality of Granola Bar Depending on Mixing Ratio of Sweetener

To prepare an optimized syrup composition, textures of the granola bars having different syrup compositions obtained with various mixing ratios of the sweeteners as shown in Table 3 were mechanically measured and sensory-evaluated.

TABLE 3
Mixing Ratios of Sweeteners

| | Contents (%) | | | | | | |
|---|---|---|---|---|---|---|---|
| Ingredients | T1 | T2 | T3 | T4 | T5 | T6 | T7 |
| Fructo- | 71.5 | 71.5 | 71.5 | 71.5 | 80.0 | 80.0 | 77.27 |
| oligosaccharide | | | | | | | |
| Erythritol | 17.8 | 13.35 | 8.9 | 15.1 | 11.2 | 7.0 | 10.78 |
| Glucose | 8.9 | 13.35 | 17.8 | 11.6 | 7.0 | 11.2 | 10.18 |
| Edible Salt | 1.8 | 1.8 | 1.8 | 1.8 | 1.8 | 1.8 | 1.8 |
| Total | 100.0 | 100.0 | 100.0 | 100.0 | 100.0 | 100.0 | 100.0 |

The granola bar was prepared in the same processing method in Example 1. After the granola bar was aged at room temperature for one day, its rupture force (Frp) was then measured using a texture analyzer. Further, the taste for textures as eating quality was sensory-evaluated. The results are shown in Table 4.

TABLE 4
Sensory Evaluation Results

| | T1 | T2 | T3 | T4 | T5 | T6 | T7 |
|---|---|---|---|---|---|---|---|
| Rupture Force | 307,012 | 289,549 | 102,359 | 93,285 | 77,983 | 66,546 | 79,983 |
| (gForce) | | | | | | | |
| Sensory | − | − | + | ++ | ++ | ++ | +++ |
| Evaluation | | | | | | | |
| Shape Retention | +++ | +++ | +++ | + | + | − | +++ |

* In the shape retention and sensory evaluation, +++ indicates very good, ++ indicates good, + indicates moderate, and − indicates poor.

As shown in Table 3, as the content of fructo-oligosaccharide rises and the content of a granular sweetener falls, the intensity is decreased, but the shape retention exhibiting moldability is proven to be poor. Accordingly, it is shown that a T7 mixing ratio satisfying both a sensory property and moldability is the most preferable.

Here, the rupture force (Frp) indicates the maximum size of power required to change the bar in height from a bottom to a certain height when the rupture force is continuously applied after being broken.

### EXPERIMENTAL EXAMPLE 2

### Evaluation of Quality of Granola Bar Depending on Content of Konjac Powder

Based on the T7 mixing ratio exhibiting the most excellent sensory property and moldability in Experimental Example 1, to provide softness to the syrup and prevent the flow of moisture, the quality of granola bar samples depending on the content of konjac powder was evaluated.

The granola bar was prepared in the same processing method as Example 1. After the granola bar was aged at room temperature for 7 days, the rupture force (Frp) was then measured using a texture analyzer. Further, to check the flow of moisture into the bar, crispiness and softness of the sample were sensory-evaluated, and the results are shown in Table 4.

TABLE 5
Evaluation Results of Crispiness and Softness of Sample

| | Content of Konjac Powder (%) | | | | |
|---|---|---|---|---|---|
| | 1 | 1.5 | 2 | 2.5 | 3 |
| Rupture Force | 78,392 | 71,498 | 72,549 | 80,132 | 87,452 |
| (gForce) | | | | | |
| Crispiness | + | ++ | +++ | +++ | +++ |
| Softness | + | ++ | +++ | ++ | + |

*In the sensory evaluation for crispiness and softness, +++ indicates very good, ++ indicates good, + indicates moderate, and − indicates poor.

As shown in Table 4, when the content of konjac powder is less than 2% by weight, the intensity is decreased. However, as the content is increased, the intensity is also increased, but the softness is decreased. In other words, an increase in the content indicates that the samples become harder, and their crispiness is constantly maintained in a content of 2% by weight or more.

Therefore, it was determined from the results that the maximum content of the konjac powder is 2% by weight.

While the invention has been shown and described with reference to certain exemplary embodiments thereof, it will be understood by those skilled in the art that various changes in form and details may be made therein without departing from the spirit and scope of the invention as defined by the appended claims.

1. A syrup composition comprising saccharides or saccharide substitutes, wherein the composition contains konjac powder.

2. The syrup composition of claim 1, wherein the konjac powder is present in a content of 1 to 5% by weight with respect to the total weight of the syrup composition.

3. The syrup composition of claim 1, which comprises fructo-oligosaccharide, erythritol, glucose, konjac powder, edible salt and water.

4. The syrup composition of claim 3, wherein, with respect to 100 parts by weight of the flucto-oligosaccharide, the erythritol is present in a content of 10 to 20 parts by weight, the glucose is present in a content of 10 to 20 parts by weight, the konjac powder is present in a content of 1 to 5 parts by weight, the edible salt is present in a content of 1 to 4 parts by weight, and the water is present in a content of 15 to 25 parts by weight.

5. A method of preparing syrup, comprising:
preparing a saccharide solution by adding 15 to 25 parts by weight of water with respect to 100 parts by weight of flucto-oligosaccharide and stirring the mixture at 70 to 90° C. for 8 to 15 minutes;
preparing syrup by adding 10 to 20 parts by weight of erythritol and 10 to 20 parts by weight of glucose to the saccharide solution, and dissolving and concentrating the ingredients at 100 to 120° C. for 40 to 60 minutes; and
adding 1 to 5 parts by weight of konjac powder and 1 to 4 parts by weight of edible salt to the syrup for maintaining suitable physical properties.
